(19) United States
(12) Patent Application Publication
(10) Pub. No.: US 2008/0250499 A1
(43) Pub. Date: Oct. 9, 2008

(54) Method and Apparatus for Reducing Buffer Overflow Exploits by Computer Viruses

(75) Inventors: Kent D. Moat, Winfield, IL (US); Ronald F. Buskey, Sleepy Hollow, IL (US); Brian G. Lucas, Florence, WI (US)

Correspondence Address: LEVEQUE INTELLECTUAL PROPERTY LAW, P.C., 221 EAST CHURCH ST., FREDERICK, MD, 21701, US

(73) Assignee: Motorola, Inc., Schaumburg, IL (US)

(21) Appl. No.: 11/694,672

(22) Filed: Mar. 30, 2007

(51) Int. Cl. G06F 21/00

(52) U.S. Cl. 726/23

(57) ABSTRACT

Buffer overflow exploits in a computer are reduced by encoding linkage information associated with a subroutine, following a call to the subroutine from an application executing on the computer. The encoded linkage information is stored at a first address in a run-time stack in a memory of the computer. Upon exit from the subroutine, the value stored at the first address in the run-time stack is retrieved and decoded to obtain decoded linkage information. Execution of the application continues in accordance with the decoded linkage information. Subroutine data written to the stack is not encoded.

### FIELD OF THE INVENTION

The present invention relates generally to computer security and, in particular, to the reduction of buffer overflow exploits by computer viruses.

### BACKGROUND

A run-time stack (also called a call-stack, execution stack, control stack or function stack, for example) in a computer is commonly used to store information about active subroutines of a program being executed on the computer. The main purpose of the run-time stack is to store the program address to which each active subroutine should return control when it finishes executing. This is called the return address. However, a typical stack may also include the calling arguments of the subroutine, the frame pointer of the subroutine caller, local variables of the subroutine being called together with a data buffer associated with the subroutine being called. A run-time stack is usually arranged as one or more frames, each frame corresponding to a subroutine.

Some computer viruses will deliberately cause a subroutine executing on a computer to overflow its data buffer on the run-time stack in hope of overwriting the subroutine return address with an address of code within the virus. Upon exiting the subroutine, the computer will then branch to the virus's code instead of returning to the calling program, thus giving execution control to the virus. A variation of this is to overwrite the return address with an address to existing code such that this code, trusting the caller, inadvertently gives control to the virus. Once the virus programmer discovers a buffer overflow exploit that works, that exploit can be used to attack all similar computers.

One common solution is to add code that ensures no subroutine will ever overflow its buffers. This adds cost by making subroutines larger and by requiring more execution time to check every buffer access.

Another prior solution is to separate the runtime stack into two stacks, one only for dynamic data allocation (i.e. buffers), and one only for subroutine linkage (i.e. return addresses). This adds cost by requiring changes to the CPU architecture to support two stacks. This means changes in the computer instruction set and consequently, a change in its software development tools.

Another solution, disclosed in EP1662379A1, is to add hardware to catch any write accesses to the return address on the stack. This doesn't affect the instruction set but does require an amount of hardware that is proportional to the maximum number of return addresses that may be on the stack at any time.

Another proposed solution, disclosed in US2003/0172293A1, is to encode application data when it is written using a technique unique to the “storage area”. The data would then be decoded using the inverse technique, again based on the storage area. Thus, any data overflow from one storage area into another would result in the overflow data being misinterpreted as nonsense when it is later decoded by a program that is using the proper decoding for the violated storage area. In this solution, return addresses are not encoded or decoded so buffer overflows would also be interpreted as nonsense. This solution requires changes to the CPU architecture so the encoding/decoding of application data happens automatically. This requires instruction set changes with the resulting changes to the software development tools. It can even require changes to the “pointer” data type so data passed by reference will know which storage area is associated with the current pointer value.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagrammatic representation of a computer system in accordance with some embodiments of the invention.

FIG. 2 is a diagrammatic representation of an exemplary run-time stack.

FIG. 3 is a block diagram of a computer system in accordance with some embodiments of the invention.

FIG. 4 is a flow chart of a method of subroutine execution consistent with certain embodiments of the present invention

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to reducing buffer overflow exploits by computer viruses. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element that is preceded by “comprises . . . a” does not, without more constraints, preclude the existence of additional identical elements in the process, method, article, or apparatus that comprises the element.

It will be appreciated that embodiments of the invention described herein may comprise one or more conventional processors and unique stored program instructions that control the one or more processors to implement some, most, or all of the functions associated with reducing buffer overflow exploits by computer viruses described herein. As such, these functions may be interpreted as a method to reduce buffer overflow exploits by computer viruses. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

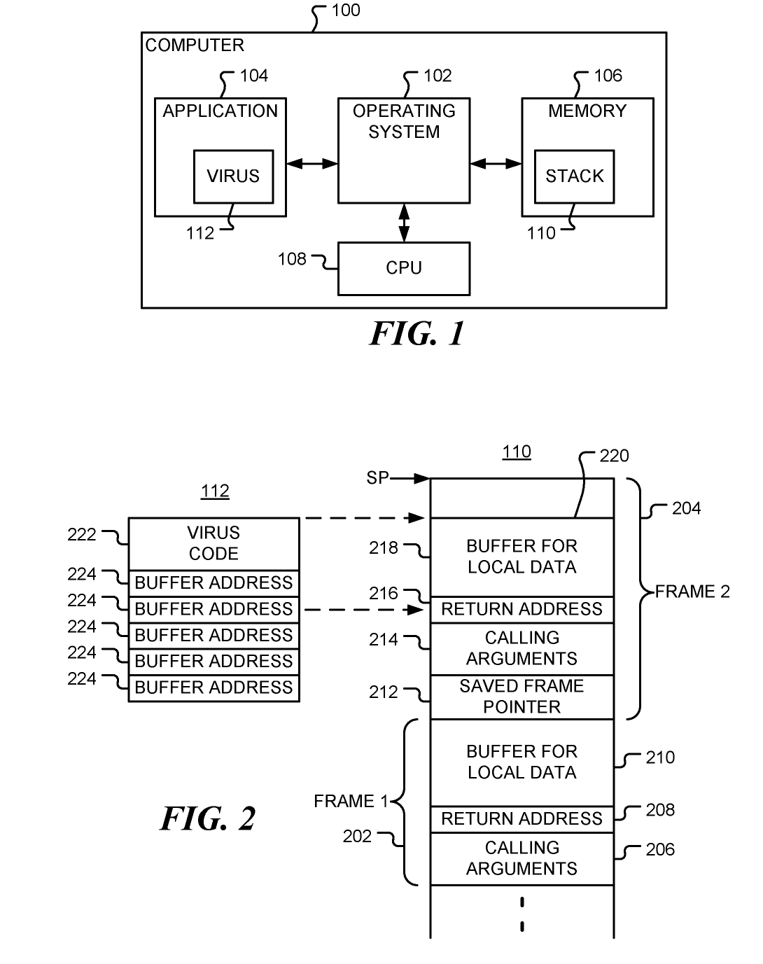

FIG. 1 is a diagrammatic representation of a computer system in accordance with some embodiments of the invention. Referring to FIG. 1, the computer system 100 has an operating system 102 that enables software applications 104 to utilize memory 106 and central processing unit 108. The memory 106 includes a run-time stack 110. A computer virus 112 is an application, or part of an application, that corrupts information stored in the memory 106 or run-time stack 110 for its own purposes, which may be malicious.

FIG. 2 is a diagrammatic representation of an exemplary run-time stack. A run-time stack is used to store linkage information associated with a subroutine of an application, during a subroutine call. In the example shown in FIG. 2, information relating to a first subroutine is stored in a first stack frame 202 (a first contiguous area of memory) and information relating to a second subroutine is stored in a second stack frame 204. The linkage information in the first frame 202 may include subroutine calling arguments 206, a return address 208 and a frame pointer 210. The stack frame may also contain a memory buffer 212 for local data associated with the first subroutine. Similarly, the linkage information in the second frame 204 may include subroutine calling arguments 214, a return address 216 and a memory buffer 218 for local data associated with the second subroutine.

New stack elements are added to the top of the stack (denoted by SP (stack pointer) in the figure). Commonly, the top of the stack is at a lower memory address than the bottom of the stack. Further, buffers are written from a low address to a high address. This creates a possibility that elements previously stored on the stack may be overwritten accidentally if the space allocated in a memory buffer is too small. In particular, an element, such as an array or string, written to a particular stack address may overwrite the return address stored in the frame. When the subroutine is exited, the return address will be incorrect and program control will branch to the wrong address.

This error may be exploited by a programmer, who can overwrite the return address with an address of his or her choosing, and so gain control of the computer. This technique is called a buffer overflow exploit.

In FIG. 2, a buffer 112 relating to a computer virus, or faulty application, is written to stack area 218 allocated for local data at location 220. The buffer 112 contains virus code 222, plus multiple pointers 224 to target virus code. The buffer 112 is too large for the stack area, so while it starts in the appropriate region, it extends beyond region 218 and overwrites the return address 216. On exit from the subroutine, the data stored in 218 will be interpreted as a return address and control will branch to the address of the virus code. A frame pointer may be overwritten using a similar technique. The compromised return address can point to virus code in the run-time stack, virus code in a global buffer, or system code (which can be used to increase privileges).

The present invention relates to a method that encodes the subroutine linkage information, such as a return address and/or a frame pointer, during a subroutine call. The encoding technique can be any reversible mapping that is unique (1) to the construction of the system, (2) to the initialization of the system, (3) to the context of the current process, or (4) to the specific subroutine call. Upon returning from a subroutine, the linkage information is decoded appropriately. If the linkage information has been overwritten by a buffer overflow, it will result in information that is, for intents and purposes, random addresses. This will make it statistically unlikely for a virus to guess the correct encoding.

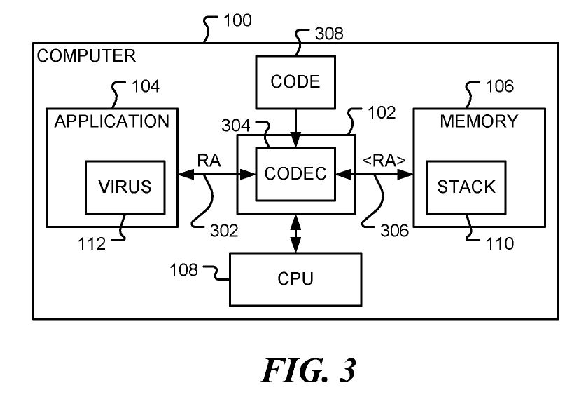

FIG. 3 is a block diagram of a computer system in accordance with some embodiments of the invention. In FIG. 3, subroutine linkage information 302, such as a return address (RA) and/or frame pointer, is passed to codec 304 that comprises an encoder and a decoder. The encoder of codec 304 encodes the linkage information and stores the encoded information 306 in the run-time stack 110 in memory 106. The encoded information 306 may be the encoded return address <RA>, for example.

In some embodiments, the codec 304 utilizes a code value 308. The code value may be unique (1) to the construction of the system, (2) to the initialization of the system, (3) to the context of the current process, or (4) to the specific subroutine call.

Upon exit from the subroutine, the encoded linkage information 306 is decoded by the decoder of codec 304 to recover the original linkage information. If the stack 110 has been corrupted by a buffer overflow, the new value at the return address location will be modified by the decoding procedure before control branches. The resulting branch will be incorrect if the stack is corrupted, but the branch cannot be controlled by a malicious programmer.

Even if the correct encoding were discovered, it is unlikely that the next system/process/subroutine would have the same encoding.

This method can be applied to existing central processing unit (CPU) architecture, with no changes needed to existing application software. Subroutine linkage information is not normally accessible to application programs, so the encoding will have no impact on existing programs. In addition, this method does not require changing the instruction set of a CPU, so no changes to software development tools are needed.

The method may require some additional hardware to select an encoding technique, presumably a register, as well as hardware to do the encoding/decoding of the linkage information during subroutine calls and returns. If the encoding technique is chosen during system construction, no further changes are needed. If the encoding is dependent the initialization of the system, the context of the current process, or the specific subroutine call, then minor changes to the operating system may be needed.

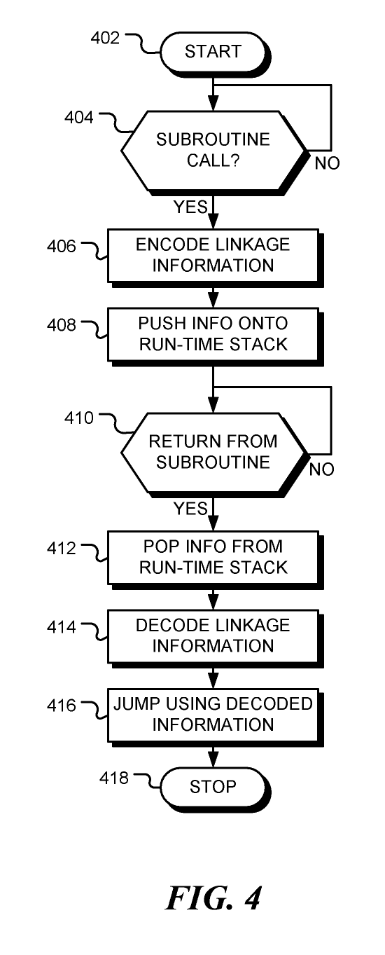

FIG. 4 is a flow chart of a method of subroutine execution consistent with certain embodiments of the present invention. Following start block 402 in FIG. 4, flow remains at decision block 404 until a subroutine is called, as depicted by the positive branch from decision block 404. When subroutine is called, the linkage information, such as the return address and/or the frame pointer, is encoded at block 406. In some embodiments, the encoding uses a random or pseudo-random code value. The code value may be, for example, a 32-bit random number that is selected when the computer is booted. The code value should be a value that is not common across computers of the same type. This makes it still more difficult for a virus to spread effectively between computers. In one embodiment, the encoded value is obtained by computing a logical exclusive-or (XOR) operation between the code value and the return address (and/or frame pointer). The encoded value, thus obtained, is pushed onto the run-time stack at block 408. When program control returns from the subroutine, as depicted by the positive branch from decision block 410, the encoded value is popped from the run-time stack at block 412. At block 414, the encoded value is decoded to retrieve the linkage information, such as the return address. At block 416, control branches in accordance with the decoded information, and the subroutine execution is completed at block 418.

If the encoded linkage information has been overwritten with, for example, the starting address of a virus code, the starting address is treated as if it was encoded data and is passed through the decoder. This alters the value, so control is not passed to the virus code.

Data written to the stack is not encoded (or is encoded using a different code value). Thus, a virus address in an over-sized data buffer will not be encoded, and will altered by the decoding process.

The method may be utilized by a variety of computers, including general purpose computers, network routers, network file servers, network client devices as well as portable embedded systems such as cellular telephones, personal digital assistants (PDA's), etc. Other applications will be apparent to those of ordinary skill in the art.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for reducing buffer overflow exploits in a computer, the method comprising:
encoding linkage information associated with execution of a call to a subroutine of an application executing on the computer;
storing the encoded linkage information at a first address on a run-time stack in a memory of the computer;
storing non-encoded data associated with the subroutine on the run-time stack;
retrieving a value stored at the first address in the run-time stack upon exit from the subroutine;
decoding the value stored at the first address to obtain decoded linkage information; and
continuing execution of the application in accordance with the decoded linkage information.

2. A method in accordance with claim 1, wherein the linkage information comprises a return address.

3. A method in accordance with claim 1, wherein the linkage information comprises a stack frame pointer.

4. A method in accordance with claim 1, wherein encoding linkage information comprises mapping the linkage information to the encoded linkage information using a reversible mapping.

5. A method in accordance with claim 4, wherein the reversible mapping is unique to at least one condition selected from the group of conditions consisting of (1) the construction of the computer, (2) an initialization of the computer, (3) a context of a process executing on the computer and (4) the specific subroutine call.

6. A method in accordance with claim 4, wherein the reversible mapping comprises a logical exclusive-or (XOR) operation between the linkage information and a code value.

7. A computer, resistant to buffer-overflow exploits, comprising:
a central processing unit operable to execute an application containing at least one subroutine;
an encoder operable to encode linkage information related to execution of the subroutine, as directed by an operating system, to produce encoded linkage information;
a memory operable to store the encoded linkage information at a first memory location, and further operable to stored non-encoded data associated with the subroutine; and
a decoder operable to decode values retrieved from the first memory location upon exit from the subroutine to produce decoded linkage information,
wherein the computer is controlled in accordance with the decoded linkage information upon exit from the subroutine.

8. A computer in accordance with claim 7, wherein the memory comprises a run-time stack.

9. An embedded system including a computer in accordance with claim 7.

10. A computer in accordance with claim 7, wherein the encoder and the decoder are responsive to a code value that is not common across multiple computers of the same type.

11. A computer in accordance with claim 7, wherein the linkage information comprises a return address.

12. A computer in accordance with claim 7, wherein the linkage information comprises a stack frame pointer.

13. A computer, resistant to buffer-overflow exploits, comprising:
encoding means for encoding linkage information associated with execution of a call to a subroutine of an application executing on the computer;
a run-time stack for storing the encoded linkage information at a first address and for storing non-encoded data associated with the subroutine; and
decoding means for decoding the value stored at the first address in the run-time stack upon exit from the subroutine to obtain decoded linkage information,
wherein the computer is operable to continue execution of the application in accordance with the decoded linkage information.

14. A computer in accordance with claim 13, wherein the encoding means is operable to map the linkage information to the encoded linkage information using a reversible mapping.

15. A computer in accordance with claim 14, wherein the reversible mapping is unique to at least one condition selected from the group of conditions consisting of (1) the construction of the computer, (2) an initialization of the computer, (3) a context of a process executing on the computer and (4) the specific subroutine call.

16. A method in accordance with claim 14, wherein the encoding means further comprises an exclusive-or (XOR) logic circuit having the linkage information and a code value as inputs and producing the encoded linkage information as output.

17. A computer in accordance with claim 14, wherein the encoding means is operable to map the linkage information to the encoded linkage information using the reversible mapping.

18. A computer in accordance with claim 17, wherein the decoding means further comprises an exclusive-or (XOR) logic circuit having the encoded linkage information and a code value as inputs and producing the decoded linkage information as output.
